(19) United States
(12) Patent Application Publication
(10) Pub. No.: US 2025/0361901 A1
(43) Pub. Date: Nov. 27, 2025

(54) Self-drilling, reusable concrete anchoring screw

(71) Applicant: Robert S Cairns, Tampa, FL (US)

(72) Inventor: Robert S Cairns, Tampa, FL (US)

(21) Appl. No.: 19/284,447

(22) Filed: Jul. 29, 2025

(51) Int. Cl. F16B 25/10; F16B 25/00

(52) U.S. Cl. CPC F16B 25/103; F16B 25/0026; F16B 25/0073

(57) ABSTRACT

A self-drilling concrete anchor screw comprising a zinc-coated shaft with graduated pitch and micro-threads, dual debris-clearing flutes, an integrated washer flange, a hex head with optional star recess, and a carbide tri-tip with a self-centering pilot point. The screw anchors directly into concrete without pre-drilling and supports multiple uses.

### BACKGROUND OF THE INVENTION

Conventional concrete screws often require pre-drilling and are prone to stripping, corrosion, or single-use limitations. Products such as Tapcon and Hilti anchors typically utilize Phillips or slotted heads with fixed diameters and limited reuse capability. There exists a need for a corrosion-resistant, high-performance concrete anchor that can self-drill without pilot holes, extract debris efficiently, and maintain thread integrity through multiple uses.

### SUMMARY OF THE INVENTION

The present invention relates to a self-drilling concrete anchor screw known as ONE SHOT—, designed for superior performance in concrete, masonry, or aggregate substrates. The screw includes a hex head with optional star bit recess, a washer-style flange, graduated pitch threads with micro-thread integration, dual debris-clearing flutes, and a self-centering 3-wing carbide tri-tip. The screw is zinc flake coated for enhanced corrosion resistance and is designed for reusability.

### BRIEF DESCRIPTION OF THE DRAWINGS

FIG. 1 is a side elevation view of the ONE SHOT² screw in its uninstalled configuration.

FIG. 2 is a side view showing the screw anchored into concrete material.

FIG. 3 is a longitudinal cross-sectional view illustrating the interaction between the screw body, flutes, and embedded concrete.

FIG. 4 is a bottom view detail of the 3-wing carbide tri-tip, showing three equally spaced cutting wings and a central pilot point for self-centering.

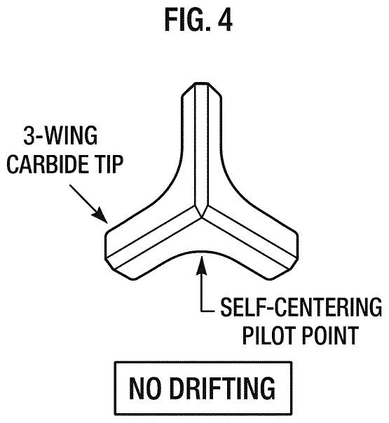

Each drawing uses consistent reference numbers to identify features including the hex head (10), optional star recess (12), screw body (14), graduated threads (16), micro-threads (18), flutes (20), carbide tri-tip (22), self-centering point (24), and flange (26).

### DETAILED DESCRIPTION OF THE INVENTION

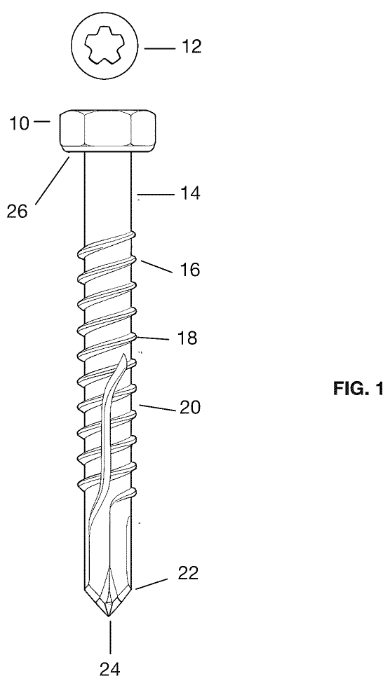

Referring to FIG. 1, the screw includes a hexagonal head (10) optionally formed with a star-shaped Torx recess (12) for dual tool compatibility.

An integrated washer-style flange (26) provides enhanced bearing surface for stability. The screw body (14) is coated with a zinc flake finish to resist corrosion, especially in marine or exterior applications.

Threading along the shaft includes a graduated pitch (16), becoming denser toward the flange and coarser toward the tip. Interspersed micro-threads (18) contribute to anchoring strength and reusability.

A pair of dust-clearing flutes (20) run longitudinally approximately one-third the length of the shaft, allowing concrete dust evacuation during drilling.

At the tip, a 3-wing carbide tri-tip (22) is formed with sharp, outwardly projecting cutting edges spaced at approximately 120 degrees.

The pilot tip (24) extends centrally beyond the wings to enable self-centering, minimizing drill wander.

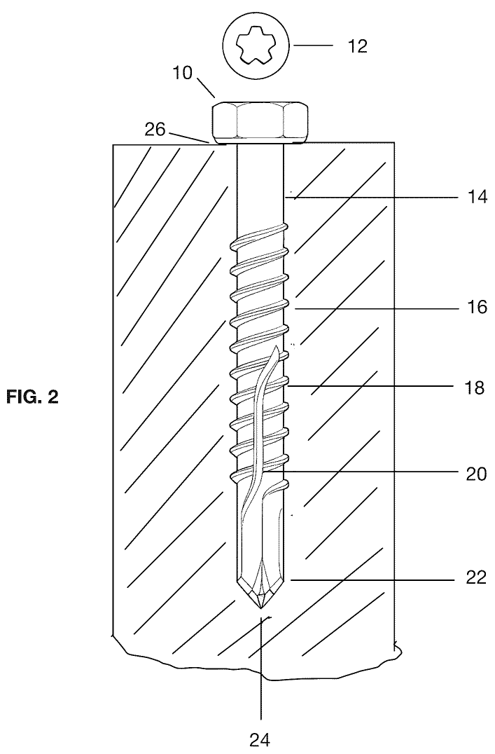

FIG. 2 shows the screw embedded in concrete, with flutes channeling dust and threads gripping the substrate.

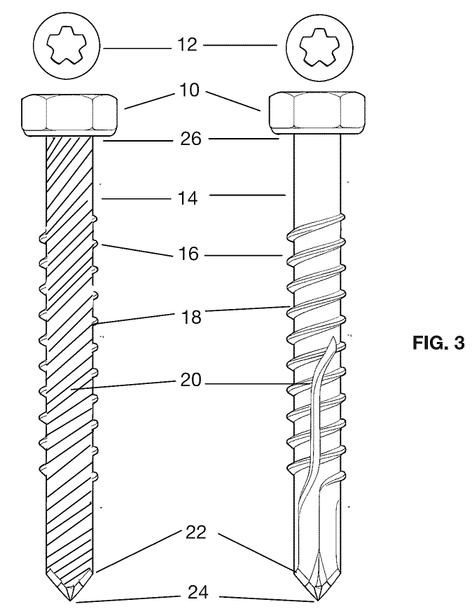

FIG. 3 illustrates the screw in cross-section, showing the internal structure of threads, flutes, coating, and tip geometry.

The ONE SHOT² screw may be manufactured in multiple length and diameter variations, including but not limited to:
Lengths: 1″, 1¼″, 1½″, 1¾″, 2″, 2¼″, 2½″, 2¾″, 3″, 3¼″, 3½″, 3¾″, 4″, 4¼″, 4½″, 4¾″, 5″, 5¼″, 5½″, 5¾″, 6″, 7″, 8″
Diameters: 3/16″, ¼″, 5/16″, ⅜″, 7/16″, ½″, ⅝″, ¾″, ⅞″, 1″

All configurations are intended to fall within the scope of the claimed invention and are capable of supporting the same cutting, anchoring, and reuse principles described herein.

1. (Independent):
A self-drilling concrete anchor screw comprising:
(a) a screw body having a hexagonal drive head optionally including a star-shaped internal recess;
(b) an integrated washer-style flange adjacent to the drive head;
(c) a zinc-coated shaft extending from the flange, said shaft including:
graduated pitch external threads;
micro-threads interspersed between primary threads;
(d) a pair of longitudinal dust-clearing flutes extending at least one-third the length of said shaft;
(e) a drilling tip formed of a three-wing carbide tri-tip geometry, including a centered pilot point for self-centering functionality,
wherein the screw is configured to drill directly into concrete without pre-drilling and permits multiple reuses without substantial thread degradation.

2. The screw of claim 1, wherein the star-shaped internal recess is a six-lobe Torx drive.

3. The screw of claim 1, wherein the flange is integrally formed with the screw head to distribute applied loads over a larger area.

4. The screw of claim 1, wherein the zinc coating is a corrosion-resistant zinc flake coating rated for exterior or marine use.

5. The screw of claim 1, wherein the micro-threads provide supplemental gripping engagement and contribute to reversible anchoring.

6. The screw of claim 1, wherein the flutes channel concrete dust from the tip region to the shaft body during installation.

7. The screw of claim 1, wherein the three carbide wings of the tip are equidistantly spaced and project from the central axis for aggressive penetration.

8. The screw of claim 1, wherein the pilot point extends beyond all three wings to facilitate centering and minimize surface drift.

9. The screw of claim 1, wherein the screw is configured in variable lengths between 1 inch and 8 inches and diameters between 3/16 inch and 1 inch.
